(19) United States
(12) Patent Application Publication
(10) Pub. No.: US 2023/0309152 A1
(43) Pub. Date: Sep. 28, 2023

(54) METHOD AND APPARATUS OF SUPPORTING DISCOVERY BURST FOR SIDELINK

(71) Applicant: Samsung Electronics Co., Ltd., Suwon-si (KR)

(72) Inventors: Hongbo Si, Plano, TX (US); Emad N. Farag, Flanders, NJ (US); Carmela Cozzo, San Diego, CA (US)

(21) Appl. No.: 18/183,740

(22) Filed: Mar. 14, 2023

Related U.S. Application Data
(60) Provisional application No. 63/323,639, filed on Mar. 25, 2022.
(60) Provisional application No. 63/327,706, filed on Apr. 5, 2022.

(51) Int. Cl. H04W 74/08; H04W 72/25; H04W 56/00

(52) U.S. Cl. CPC H04W 74/0891; H04W 72/25; H04W 56/0015; H04W 74/0816

(57) ABSTRACT

Methods and apparatuses for discovery burst transmission for a sidelink (SL) in a wireless communication system. A method of a user equipment (UE) includes identifying a set of sidelink (SL) synchronization signals and physical SL broadcast channel (S-SS/PSBCH) blocks for a SL discovery burst, determining a transmission duration of the SL discovery burst, and determining a duty cycle of the SL discovery burst. The method further includes determining, based on the transmission duration and the duty cycle, a type of SL channel access procedure; performing, based on the type of SL channel access procedure, a SL channel access procedure; and transmitting the SL discovery burst after successfully performing the SL channel access procedure.

### CROSS-REFERENCE TO RELATED APPLICATIONS AND CLAIM OF PRIORITY

The present application claims priority to U.S. Provisional Patent Application No. 63/323,639, filed on Mar. 25, 2022, and U.S. Provisional Patent Application No. 63/327,706, filed on Apr. 5, 2022. The contents of the above-identified patent document are incorporated herein by reference.

### TECHNICAL FIELD

The present disclosure relates generally to wireless communication systems and, more specifically, the present disclosure relates to support for discovery burst transmissions on a sidelink (SL) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to support for discovery burst transmissions on a SL in a wireless communication system.

In one embodiment, a user equipment (UE) in a wireless communication system is provided. The UE includes a processor configured to identify a set of SL synchronization signals and physical SL broadcast channel (S-SS/PSBCH) blocks for a SL discovery burst; determine a transmission duration of the SL discovery burst; determine a duty cycle of the SL discovery burst; determine, based on the transmission duration and the duty cycle, a type of SL channel access procedure; and perform, based on the type of SL channel access procedure, a SL channel access procedure. The UE further includes a transceiver operably coupled to the processor. The transceiver is configured to transmit the SL discovery burst after successfully performing the SL channel access procedure.

In another embodiment, a method of a UE in a wireless communication system is provided. The method includes identifying a set of S-SS/PSBCH blocks for a SL discovery burst, determining a transmission duration of the SL discovery burst, and determining a duty cycle of the SL discovery burst. The method further includes determining, based on the transmission duration and the duty cycle, a type of SL channel access procedure; performing, based on the type of SL channel access procedure, a SL channel access procedure; and transmitting the SL discovery burst after successfully performing the SL channel access procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of a resource pool in Rel-16 NR V2X according to embodiments of the present disclosure;

FIG. 7 illustrates an example of discovery burst in NR-U according to embodiments of the present disclosure;

FIG. 8 illustrates an example of secondary resource pool according to embodiments of the present disclosure;

FIG. 9 illustrates an example of extended resource pool according to embodiments of the present disclosure;

FIG. 10 illustrates an example of multiplexing within a sidelink discovery burst according to embodiments of the present disclosure;

FIG. 11 illustrates a flowchart of a UE procedure for receiving components included in a discovery burst in the secondary resource pool according to embodiments of the present disclosure;

FIG. 12 illustrates a flowchart of UE procedure for transmitting components included in a discovery burst in the secondary resource pool according to embodiments of the present disclosure;

FIG. 13 illustrates an example of S-SS/PBCH block structure according to embodiments of the present disclosure;

FIG. 14 illustrates an example of structure for a S-SS/PSBCH block according to embodiments of the present disclosure;

FIG. 15 illustrates an example of mapping of sequence for S-PSS and/or S-SSS in frequency domain according to embodiments of the present disclosure;

FIG. 16 illustrates an example of mapping of sequence for S-PSS and/or S-SSS in frequency domain according to embodiments of the present disclosure;

FIG. 17 illustrates an example of S-SS/PSBCH block transmission pattern according to embodiments of the present disclosure; and

FIG. 18 illustrates a flowchart of a UE procedure on receiving S-SS/PSBCH block based on the type of S-SS/PSBCH block according to embodiments of the present disclosure.

### DETAILED DESCRIPTION

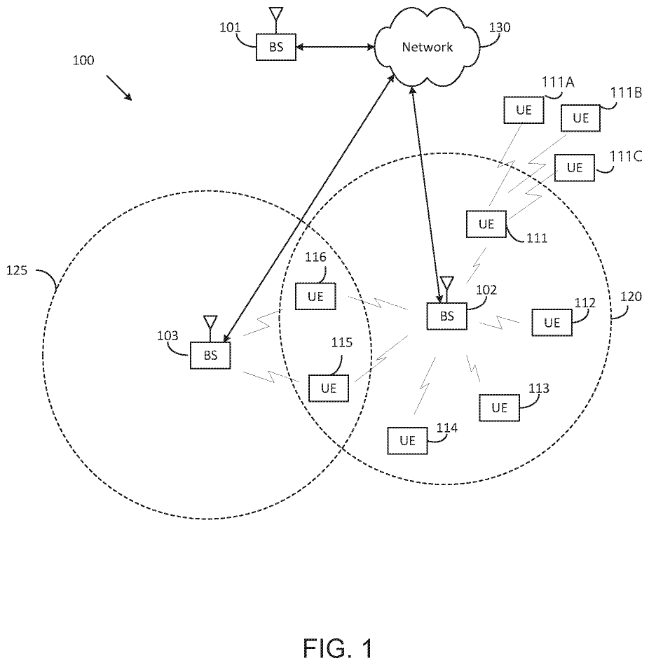

FIG. 1 through FIG. 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; and 3GPP TS 38.331 v16.1.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, embodiments of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support discovery burst transmissions on a SL in a wireless communication system. In certain embodiments, one or more of the gNBs 101-103 includes circuitry, programing, or a combination thereof, for supporting discovery burst transmissions on a SL in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

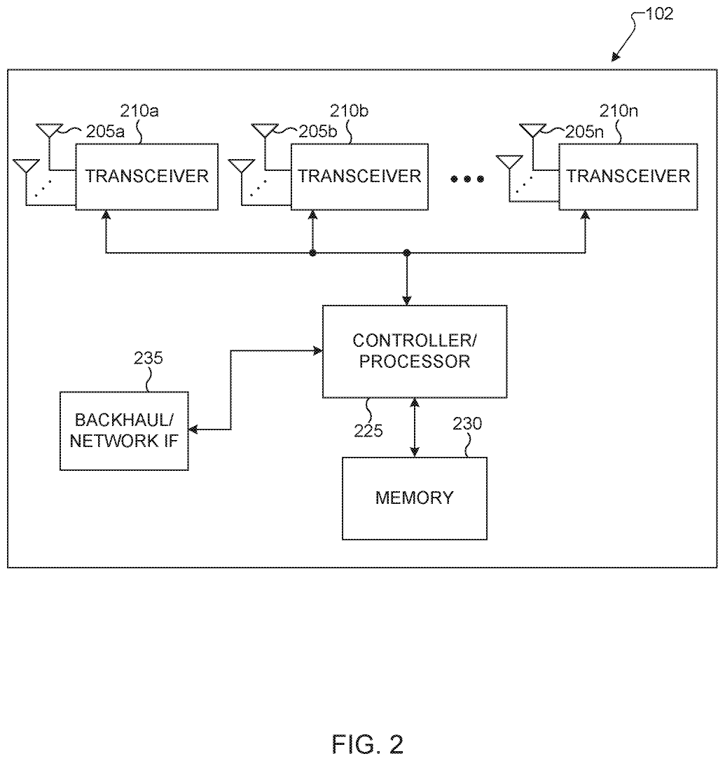

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support discovery burst transmissions on a SL in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

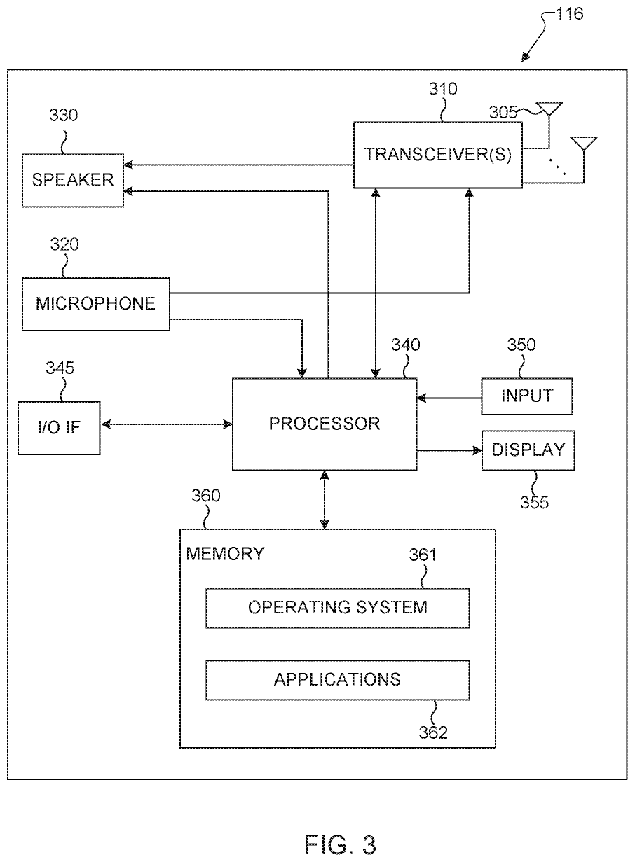

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes to support discovery burst transmissions on a SL in a wireless communication system. The processor 340 can move data into or out of the memory 360 as required by an executing process. In some embodiments, the processor 340 is configured to execute the applications 362 based on the OS 361 or in response to signals received from gNB s or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

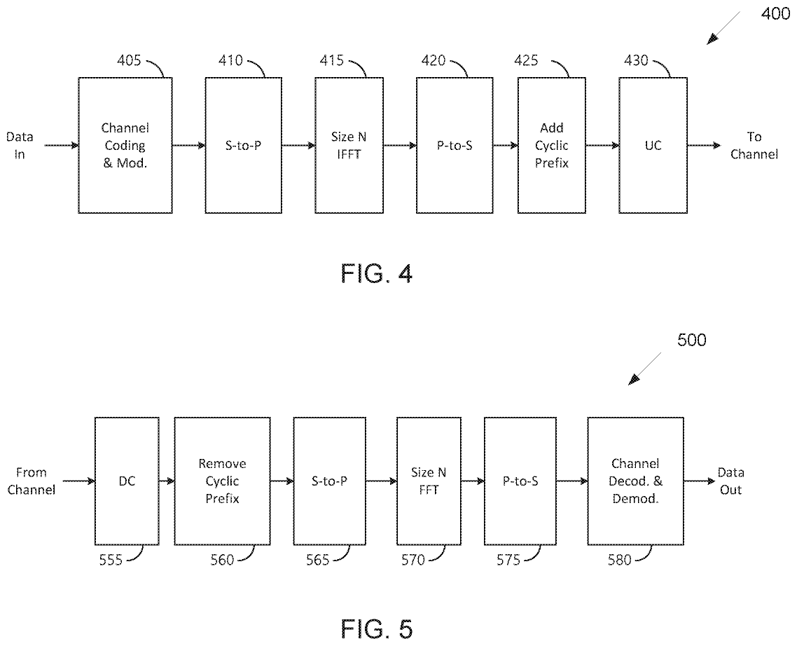

FIG. 4 and FIG. 5 illustrate example wireless transmit and receive paths according to the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support discovery burst transmissions on a SL in a wireless communication system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

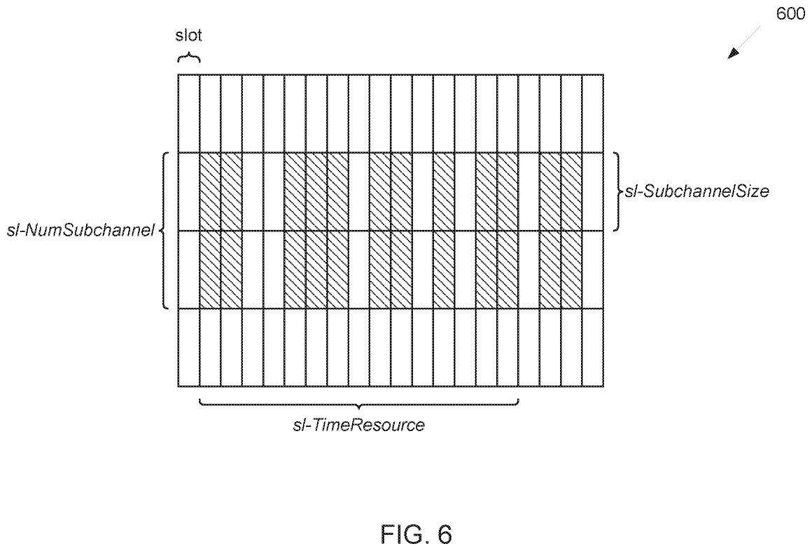

In Rel-16 NR V2X, transmission and reception of sidelink (SL) signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of a resource pool in Rel-16 NR V2X 600 according to embodiments of the present disclosure. An embodiment of the resource pool in Rel-16 NR V2X 600 shown in FIG. 6 is for illustration only.

Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for AGC purpose. The UE may not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

In NR sidelink, sidelink synchronization signals and physical sidelink broadcast channel block (S-SS/PSBCH block or S-SSB) is supported. One S-SS/PSBCH block consists of 132 contiguous subcarriers (SC) in frequency domain and 13 contiguous symbols for normal CP or 11 contiguous symbols for extended CP in time domain. Within a S-SS/PSBCH block, sidelink primary synchronization signal (S-PSS) is mapped to symbol #1 and #2, and sidelink secondary synchronization signal (S-SSS) is mapped to symbol #3 and #4, wherein subcarriers with index 2 to 128 (127 subcarriers in total) are mapped for S-PSS or S-SSS in frequency domain, while subcarriers with index 0, 1, 129, 130, and 131 are set as zero. PSBCH is mapped to symbol #0 and #5 to #N_{symb}^{S-SSB}−1, with DM-RS for PSBCH multiplexed in the symbols, wherein N_{symb}^{S-SSB}=13 for normal CP and N_{symb}^{S-SSB}=11 for extended CP. A summary of the mapping in time and frequency domain is shown in TABLE 1.

TABLE 1
Resource mapping within a S-SS/PSBCH block.

| Signal or channel | Symbol index | Subcarrier index |
|---|---|---|
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N_{symb}^{S-SSB} − 1 | 0, 1, . . . , 130, 131 |
| DM-RS for PSBCH | 0, 5, 6, . . . , N_{symb}^{S-SSB} − 1 | 0, 4, . . . , 124, 128 |

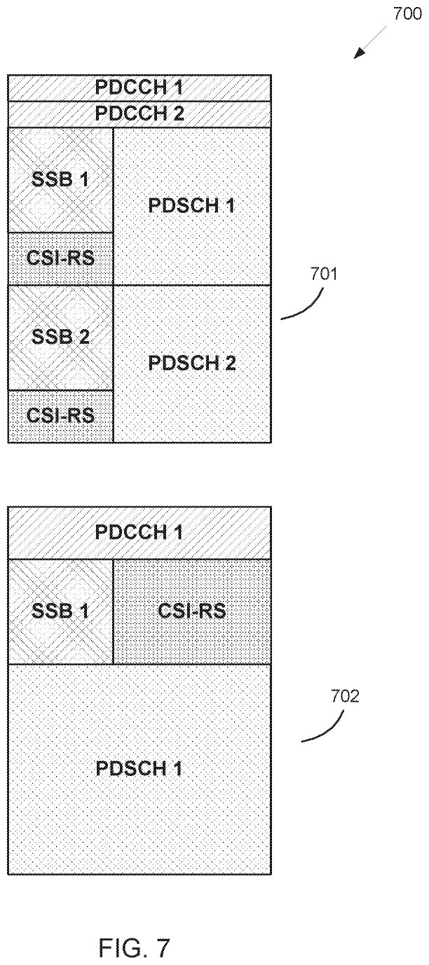

In Rel-16 NR-U, a discovery burst was supported, wherein the discovery burst refers to a DL transmission burst including a set of signal(s) and/or channel(s) confined within a window and associated with a duty cycle, and the discovery burst includes at least an SS/PBCH block consisting of a primary synchronization signal (PSS), secondary synchronization signal (SSS), physical broadcast channel (PBCH) with associated demodulation reference signal (DM-RS) and may also include CORESET for PDCCH scheduling PDSCH with SIB1, and PDSCH carrying SIB1 and/or non-zero power CSI reference signals (CSI-RS). The components of a discovery burst can be multiplexed and forms a burst without gap in time domain, and an illustration of examples for discovery burst in NR-U is shown in FIG. 7. The transmission of discovery burst can utilize short and deterministic sensing duration (e.g., Type 2 DL channel access procedure) and apply a lower energy detection threshold.

FIG. 7 illustrates an example of discovery burst in NR-U 700 according to embodiments of the present disclosure. An embodiment of the discovery burst in NR-U 700 shown in FIG. 7 is for illustration only.

For a sidelink operated over an unlicensed spectrum, the transmission of sidelink signals and channels may be subject to the occupied channel bandwidth (OCB) requirement, due to the requirement of regulation for the unlicensed spectrum. For example, for 5 GHz unlicensed spectrum, at least 80% of the nominal channel bandwidth needs to be satisfied when transmitting. The S-SS/PSBCH block has 11 RBs in the frequency domain, which cannot satisfy the OCB requirement if not multiplexed with other SL signal/channel. Hence, in order to meet the OCB requirement, supporting multiplexing SL signal/channel with S-SS/PSBCH block could be one method. This disclosure addresses such enhancement for supporting sidelink discovery burst (S-DB), wherein the terminology of discovery burst could be referred to as equivalent terminologies, such as short control signal, discovery signal, discovery signal and channel.

The present disclosure provides a discovery burst on sidelink unlicensed spectrum, such that the transmission of S-SS/PSBCH block can satisfy the OCB requirement of the channel on the unlicensed spectrum. More precisely, the present disclosure includes the following components: (1) aspects included in the sidelink discovery burst; (2) indication for discovery burst; (3) impact to resource pool; (4) multiplexing of the components in sidelink discovery burst; (5) channel access procedure for discovery burst; and (6) example UE procedure for discovery burst. The disclosed components support discovery burst on sidelink unlicensed spectrum, such that the transmission of S-SS/PSBCH block satisfies the OCB requirement of the channel on the unlicensed spectrum.

In one embodiment, a discovery burst is supported for sidelink, where the sidelink discovery burst (S-DB) is a sidelink transmission burst including a set of signal(s) and/or channel(s). The embodiments of this embodiment can operate in conjunction or in combination with one another, or can operate as standalone ones.

For one example, the transmission of the S-DB can be confined within a window.

For another example, the transmission of the S-DB can be associated with a duty cycle.

In one embodiment, at least one of the following examples can be included in a S-DB.

In one example, S-SS/PSBCH block can be included in a S-DB, wherein a S-SS/PSBCH block includes S-PSS, S-SSS, and PSBCH (with associated DM-RS for the PSBCH).

In another example, PSFCH can be included in a S-DB. For instance, the PSFCH can be transmitted by the same UE when other examples are included in the S-DB.

In yet another example, PSCCH can be included in a S-DB. In one example, the DM-RS for PSCCH can be included in the S-DB as well.

In yet another example, PSSCH can be included in a S-DB. In one example, the DM-RS for PSSCH can be included in the S-DB as well. In another example, the PT-RS for PSSCH can be included in the S-DB as well.

In yet another example, CSI-RS can be included in a S-DB.

In yet another example, sidelink positioning reference signal (SL-PRS) can be included in a S-DB.

In another embodiment, at least one of the examples can be defaulted to be included in the S-DB, and at least one of the examples can be optional to be included in the S-DB (e.g., based on configuration or pre-configuration). For instance, S-SS/PBCH block can be defaulted to be included in the S-DB, and at least one of the remaining examples can be optional to be included in the S-DB.

In yet another embodiment, there can be a further requirement on the priority (e.g., transmission priority) of the at least one example to be included in the S-DB. For instance, there can be at least one priority threshold for the priority (e.g., transmission priority) of the at least one example to be included in the S-DB, and an example (e.g., S-SS/PSBCH block, and/or PSFCH) can be included in the S-DB, if its priority (e.g., transmission priority) is higher (or no lower than) than the threshold.

In one example, the at least one threshold can be determined separately for each of the examples.

In another example, the at least one threshold can be common for at least some of the examples (or all the examples).

In one example, at least one of the threshold(s) can be pre-configured.

In another example, at least one of the threshold(s) can be provided by a higher layer parameter.

In yet another example, at least one of the threshold(s) can be fixed in the specification (e.g., fixing at least one of the threshold(s) as 1).

In yet another example, at least one the threshold(s) can be determined based on the priority (e.g., transmission priority) of at least one example included in the S-DB. For instance, at least one the threshold(s) can be determined based on the priority (e.g., transmission priority) of the example included in the S-DB by default (e.g., S-SS/PSBCH block).

In yet another embodiment, there can be a further requirement on the transmission identity for the at least one example to be included in the S-DB. For instance, the transmitter identity of the examples included in the S-DB is the same.

In yet another embodiment, there can be a further requirement on the reception identity for the at least one example to be included in the S -DB. For one instance, the reception identities of the examples included in the S-DB are the same. For another instance, the reception identities of the example(s) optionally included in the S-DB are same or a subset of the reception identities of the example(s) included in the S-DB by default.

In yet another embodiment, there can be a further requirement on the quasi-colocation (QCL) assumption or TCI state for the at least one example to be included in the S -DB. For one instance, the QCL assumption or TCI state of at least some of the examples included in the S -DB is the same.

In yet another embodiment, there can be a further requirement on the cast type of the transmission. For one instance, it may require the cast type of a PSSCH transmission to be broadcast, such that it can be included in the S-DB. For another instance, it may require the cast type of a PSSCH transmission to be groupcast, such that it can be included in the S-DB. For yet another instance, it may require the cast type of the corresponding PSFCH transmission to be groupcast, such that a PSFCH transmission can be included in the S-DB.

In one embodiment, there can be at least an indication for discovery burst supported for sidelink.

For one example, there can be at least an indication on whether or not S-DB is supported.

For another example, there can be at least an indication on whether each or some of the candidate component(s) possibly included in the S-DB is included in the S-DB.

For one instance, if there are N candidate components possibly included in the S-DB (e.g., each candidate component can be according to the example described in this disclosure), then the indication can include a group of N bits (e.g., a bitmap with length as N), wherein each bit corresponds to a candidate component, and the bit taking value of 1 (or “enabled”) refers to the corresponding candidate component is included in the S-DB, and the bit taking value of 0 (or “disabled”) refers to the corresponding candidate component is not included in the S-DB.

For one instance, if there are N candidate optional components possibly included in the S-DB (e.g., each candidate optional component can be according to the example described in this disclosure), then the indication can include a group of N bits (e.g., a bitmap with length as N), wherein each bit corresponds to a candidate optional component, and the bit taking value of 1 (or “enabled”) refers to the corresponding candidate optional component is included in the S-DB, and the bit taking value of 0 (or “disabled”) refers to the corresponding candidate optional component is not included in the S-DB.

For yet another example, there can be at least an indication on which component(s) are included in the S-DB, wherein the indication is a list of component(s) included in the S-DB and each component can be according to the example described in this disclosure.

For yet another example, there can be at least an indication on which optional component(s) are included in the S-DB, wherein the indication is a list of optional component(s) included in the S-DB and each optional component can be according to the example described in this disclosure.

For one example, at least one indication from the above examples can be included in a higher layer parameter provided by a gNB.

For another example, at least one indication from the above examples can be included in a higher layer parameter provided by a UE.

For yet another example, at least one indication from the above examples can be included in a pre-configuration.

For one example, at least one indication from the above examples can be cell-specific.

For another example, at least one indication from the above examples can be UE-specific.

For yet another example, at least one indication from the above examples can be associated with a BWP.

For yet another example, at least one indication from the above examples can be associated with a resource pool.

For yet another example, at least one indication from the above examples can be per carrier.

In one embodiment, the time domain resource of the legacy resource pool excludes the slots including S-SS/PSBCH block(s), and at least one secondary resource pool (or with equivalent terminology as “extra resource pool,” “additional resource pool,” or “resource pool for discovery burst”, or “special resource pool”) can be supported based on the slots including S-SS/PSBCH block(s), e.g., the time domain resource of the at least one secondary resource pool is same as the slots including S-SS/PSBCH block(s). For one instance, the S-SS/PSBCH block(s) can be further limited to the ones that are not overlapping with legacy (pre-)configured S-SS/PSBCH blocks (e.g., additional candidate S-SS/PSBCH blocks for enhancing channel access opportunity). For another instance, the secondary resource pool can also be considered as a subset of resource from the legacy resource pool, wherein the secondary resource pool are based on the slots that include additional candidate S-SS/PSBCH blocks (e.g., for enhancing channel access opportunity).

For one example, at least one of the parameters for the (pre-)configuration of the legacy resource pool can be separately (pre-)configured for the secondary resource pool.

In one example, the at least one secondary resource pool includes RB-set(s) that do not overlap or include S-SS/PSBCH block(s). For instance, the sub-channel(s) or RB(s) in a RB-set that includes or overlaps with S-SS/PSBCH block(s) are not included in the at least one secondary resource pool.

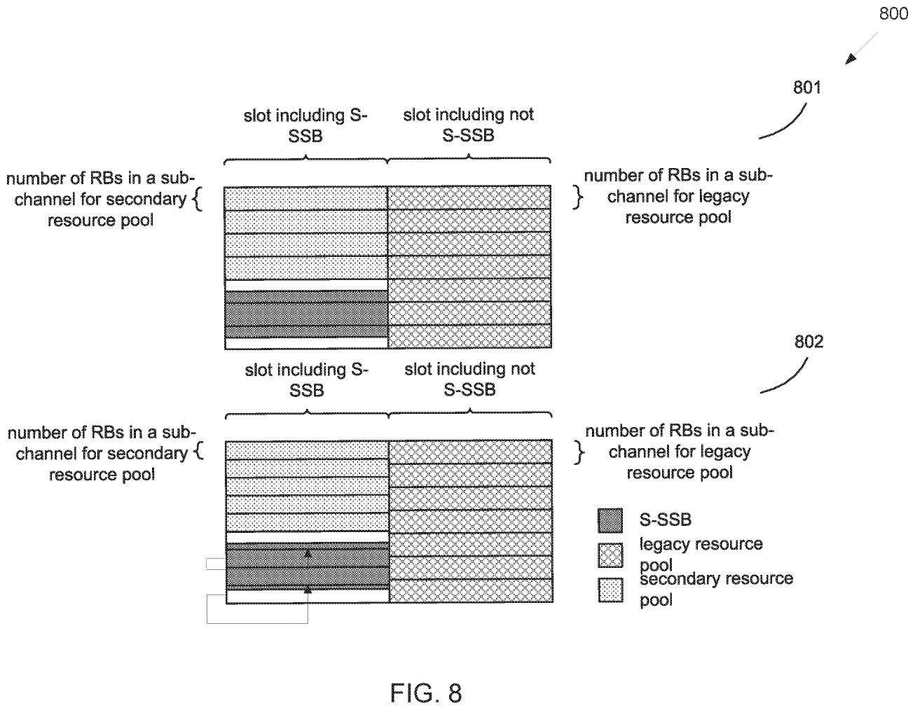

In one example, the at least one secondary resource pool shares the same sub-channel grids as the legacy resource pool, e.g., the number of RBs in a sub-channel and the starting RB of the first sub-channel in the BWP are common for the at least one secondary resource pool and the legacy resource pool. An illustration of this example is shown in 801 of FIG. 8.

FIG. 8 illustrates an example of secondary resource pool 800 according to embodiments of the present disclosure. An embodiment of the secondary resource pool 800 shown in FIG. 8 is for illustration only.

In one sub-example, the sub-channels included in the at least one secondary resource pool can be determined as the sub-channels included in the legacy resource pool (e.g., using a common (pre-)configuration), but excluding the sub-channels that overlap with the S-SS/PSBCH block.

In another sub-example, the sub-channels included in the at least one secondary resource pool can be determined as same as the sub-channels included in the legacy resource pool (e.g., using a common (pre-)configuration). Within the frequency resources of the at least one secondary resource pool, sub-channels that overlap with the S-SS/PSBCH block are not available for transmission or reception of other components included in the S-DB.

In yet another sub-example, the sub-channels included in the at least one secondary resource pool can be separately determined (e.g., based on a separate (pre-)configuration associated with the at least one secondary resource pool), such that the sub-channels overlapping with S-SS/PSBCH block are not included in the at least one secondary resource pool.

In yet another sub-example, the sub-channels included in the at least one secondary resource pool can be separately determined (e.g., based on a separate (pre-)configuration associated with the at least one secondary resource pool). Within the frequency resources of the at least one secondary resource pool, sub-channels that overlap with the S-SS/PSBCH block are not available for transmission or reception of other components included in the S-DB.

In another example, at least one of the number of RBs in a sub-channel for the secondary resource pool, the starting RB index of the first sub-channel, or the sub-channels included in the at least one secondary resource pool can be (pre-)configuration using a (pre-) configuration separate from the legacy resource pool. An illustration of this example is shown in 802 of FIG. 8.

In one sub-example, the sub-channels included in the at least one secondary resource pool can be determined such that the sub-channels overlapping with S-SS/PSBCH block are not included in the at least one secondary resource pool.

In another sub-example, within the frequency resources of the at least one secondary resource pool, sub-channels that overlap with the S-SS/PSBCH block are not available for transmission or reception of other components included in the S-DB.

In another embodiment, the time domain resource of the legacy resource pool can be extended to include the slot(s) including the S-SS/PSBCH block(s).

In various embodiments, the UE may transmit a SL positioning reference signal (SL-PRS) based on the secondary resource pool. For another example, the UE may transmit a PSSCH/PSCCH based on the secondary resource pool. For yet another example, the UE may transmit a PSFCH based on the secondary resource pool.

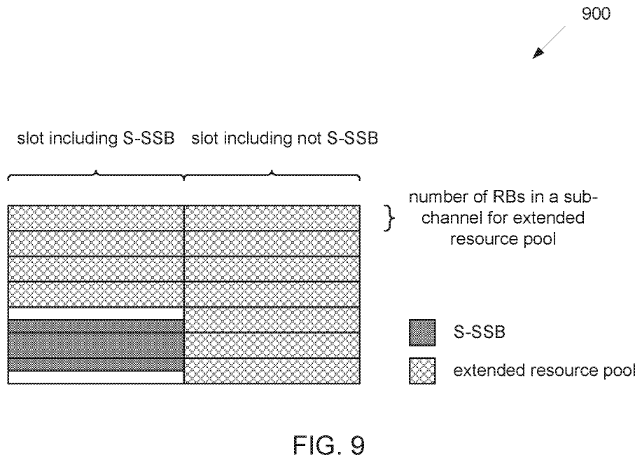

For one example, the sub-channels overlapping with the S-SS/PSBCH block in the slot(s) including S-SS/PSBCH block(s) are not available for transmission or reception of SL signal(s) or channel(s) other than the ones included in the S-SS/PSBCH block. An illustration of this example is shown in FIG. 9.

FIG. 9 illustrates an example of extended resource pool 900 according to embodiments of the present disclosure. An embodiment of the extended resource pool 900 shown in FIG. 9 is for illustration only.

In one example, when PSFCH can be a candidate component to be included in a S-DB, at least one parameter in the (pre-)configuration of PSFCH can be a separate one when it's included in the S-DB. For instance, at least one of the period of the associated time domain resource for mapping to the PSFCH, the available frequency domain resource (e.g., RB) for transmitting the PSFCH, the number of cyclic shift pairs used for PSFCH, the minimum time domain gap between PSFCH and associated PSSCH, a scrambling ID for sequence hopping of the PSFCH, or the PSFCH candidate resource type could be a separate (pre-)configuration, e.g., to be associated with the secondary resource pool if supported, or to be different from the legacy (pre-)configuration associated with the legacy resource pool when the extended resource pool is supported.

In another example, when PSCCH can be a candidate component to be included in a S-DB, at least one parameter in the (pre-)configuration of PSCCH can be a separate one when it's included in the S-DB. For instance, at least one of a number of symbols for PSCCH, a number of frequency domain resources (e.g., RBs) for PSCCH, a scrambling ID of the DM-RS for the PSCCH, or a number of reserved bits in the first stage SCI could be a separate (pre-)configuration, e.g., to be associated with the secondary resource pool if supported, or to be different from the legacy (pre-)configuration associated with the legacy resource pool when the extended resource pool is supported.

In yet another example, when PSSCH can be a candidate component to be included in a S-DB, at least one parameter in the (pre-)configuration of PSSCH can be a separate one when it's included in the S-DB. For instance, at least one of a DM-RS pattern for PSSCH, a power offset for the second stage SCI, or a scaling factor for limiting the number of REs assigned for the second stage SCI could be a separate (pre-)configuration, e.g., to be associated with the secondary resource pool if supported, or to be different from the legacy (pre-)configuration associated with the legacy resource pool when the extended resource pool is supported.

In yet another example, when PT-RS can be a candidate component to be included in a S-DB, at least one parameter in the (pre-)configuration of PT-RS can be a separate one when it's included in the S-DB. For instance, at least one of a frequency domain density for PT-RS, a time domain density for PT-RS, or a RE offset value for PT-RS could be a separate (pre-)configuration, e.g., to be associated with the secondary resource pool if supported, or to be different from the legacy (pre-)configuration associated with the legacy resource pool when the extended resource pool is supported.

In yet another example, when CSI-RS can be a candidate component to be included in a S-DB, at least one parameter in the (pre-)configuration of CSI-RS can be a separate one when it's included in the S-DB. For instance, the at least one of a frequency allocation of CSI-RS or a time domain allocation of CSI-RS (e.g., symbol index) could be a separate (pre-)configuration, e.g., to be associated with the secondary resource pool if supported, or to be different from the legacy (pre-)configuration associated with the legacy resource pool when the extended resource pool is supported.

In yet another example, when SL-PRS can be a candidate component to be included in a S-DB, at least one parameter in the (pre-)configuration of SL-PRS can be a separate one when it's included in the S-DB. For instance, the at least one of a frequency allocation of SL-PRS or a time domain allocation of SL-PRS (e.g., symbol index) could be a separate (pre-)configuration, e.g., to be associated with the secondary resource pool if supported, or to be different from the legacy (pre-)configuration associated with the legacy resource pool when the extended resource pool is supported.

In one embodiment, components included in a S-DB can be multiplexed to construct a burst.

In one example, when S-SS/PSBCH block(s) and other component(s) (e.g., according to example(s) of this disclosure) are included in the S-DB, the other components can be frequency division multiplexed (FDMed) with a S-SS/PSBCH block within the slot(s) including the S-SS/PSBCH block(s).

In one example, the FDMed other components in the S-DB are transmitted in the available sub-channels for SL transmission/reception in the extended resource pool or secondary resource pool, as described in the examples of this disclosure.

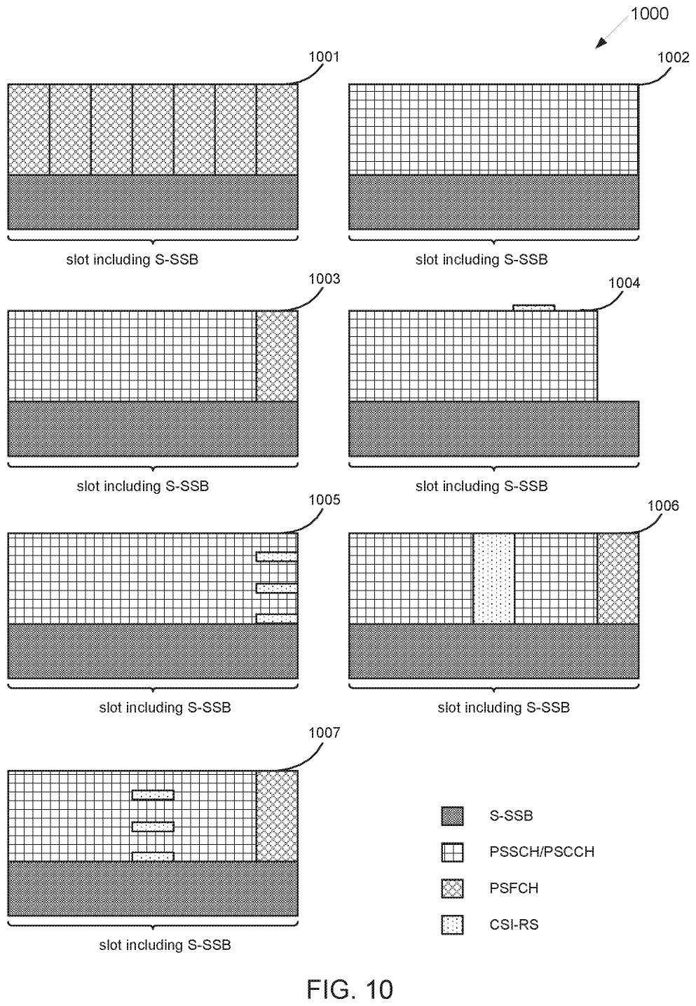

For one sub-example, when S-SS/PSBCH block(s) and PSFCH are included in the S-DB, the transmission occasion(s) of PSFCH can be TDMed, and then the set of transmission occasion(s) of PSFCH can be further FDMed with the S-SS/PSBCH block. An illustration of this sub-example is shown in 1001 of FIG. 10.

FIG. 10 illustrates an example of multiplexing within a sidelink discovery burst 1000 according to embodiments of the present disclosure. An embodiment of the multiplexing within a sidelink discovery burst 1000 shown in FIG. 10 is for illustration only.

For another sub-example, when S-SS/PSBCH block(s) and PSSCH/PSCCH/SL-PRS are included in the S-DB, the transmission of the PSSCH/PSCCH/SL-PRS can be FDMed with the S-SS/PSBCH block. An illustration of this sub-example is shown in 1002 of FIG. 10.

For yet another sub-example, when S-SS/PSBCH block(s), PSSCH/PSCCH, and PSFCH are included in the S-DB, the transmission of the PSSCH/PSCCH and the PSFCH can be TDMed, and then the transmission of PSSCH/PSCCH/PSFCH can be further FDMed with the S-SS/PSBCH block. An illustration of this sub-example is shown in 1003 of FIG. 10.

For yet another sub-example, when S-SS/PSBCH block(s), at least one PSSCH/PSCCH, and CSI-RS are included in the S-DB, the transmission of the at least one PSSCH/PSCCH and the CSI-RS can be multiplexed (e.g., PSSCH/PSCCH and CSI-RS TDMed, or CSI-RS IFDMed within at least one symbol for PSSCH/PSCCH), and then the transmission of PSSCH/PSCCH/CSI-RS can be further FDMed with the S-SS/PSBCH block. An illustration of this sub-example is shown in 1004 (e.g., PSSCH/PSCCH and CSI-RS TDMed) or 1005 (e.g., CSI-RS IFDMed within at least one symbol for PSSCH/PSCCH) of FIG. 10.

For yet another sub-example, when S-SS/PSBCH block(s), at least one PSSCH/PSCCH, PSFCH, and CSI-RS are included in the S-DB, the transmission of the at least one PSSCH/PSCCH, the PSFCH, and the CSI-RS can be multiplexed (e.g., PSSCH/PSCCH, PSFCH and CSI-RS TDMed, or PSSCH/PSCCH and PSFCH TDMed and CSI-RS IFDMed within at least one symbol for PSSCH/PSCCH), and then the transmission of PSSCH/PSCCH/PSFCH/CSI-RS can be further FDMed with the S-SS/PSBCH block. An illustration of this sub-example is shown in 1006 (e.g., PSSCH/PSCCH, PSFCH and CSI-RS TDMed) or 1007 (e.g., PSSCH/PSCCH and PSFCH TDMed and CSI-RS IFDMed within at least one symbol for PSSCH/PSCCH) of FIG. 10.

In one example for the sub-examples above, there could be further time gap between the signals/channels that are TDMed, although not explicitly illustrated in FIG. 10.

In another example for the sub-examples above, there could be further frequency gap between the S-SS/PSBCH block and other signals/channels that are FDMed, although not explicitly illustrated in FIG. 10.

In yet another example for the sub-examples above, the number of symbols and/or the number of RBs/REs for SL signal/channel are for illustration purpose, and the actual number of symbols and/or the number of RBs/REs for SL signal/channel are according to the examples described in this disclosure.

In yet another example for the sub-examples above, there could be a PSFCH format supported wherein the PSFCH transmission spans one or multiple sub-channels (e.g., contiguous sub-channels), e.g., when the PSFCH is FDMed with the S-SS/PSBCH block and/or when the PSFCH is a component for discovery burst.

In yet another example for the sub-examples above, there could be a configuration of CSI-RS supported wherein the CSI-RS transmission spans one or multiple sub-channels (e.g., contiguous sub-channels), when the PSFCH is FDMed with the S-SS/PSBCH block and/or when the PSFCH is a component for discovery burst.

In yet another example for the sub-examples above, there could be multiple of the sub-examples above supported at the same time. For instance, based on the time domain allocation of the other components in the discovery burst (e.g., periodicity and/or offset), one of the sub-examples can take place on a first time instance, and another of the sub-examples can take place on a second time instance.

In another example, when S-SS/PSBCH block(s) and other component(s) (e.g., according to example(s) of this disclosure) are included in the S-DB, the other components can be time division multiplexed (TDMed) with S-SS/PSBCH block(s), e.g., to be located in the slot(s) not including the S-SS/PSBCH block(s).

In yet another example, when S-SS/PSBCH block(s) and other component(s) (e.g., according to example(s) of this disclosure) are included in the S-DB, the other components can be either FDMed or TDMed with S-SS/PSBCH block(s), e.g., to be located in both the slot(s) including the S-SS/PSBCH block(s) and the slot(s) not including the S-SS/PSBCH block(s). For instance, at least one example described in this disclosure (e.g., illustrated in FIG. 10) can be used for the components in discovery burst being FDMed.

In one embodiment, the channel access procedure for discovery burst can be determined based on the duty cycle of the discovery burst and/or the transmission duration of the discovery burst.

For one example, when the duty cycle of the discovery burst is larger than (or no smaller than) a first threshold, and/or the transmission duration of the discovery burst is larger than (or no smaller than) a second threshold, the discovery burst can use a first type of channel access procedure, wherein the channel sensing duration in the first type of channel access procedure is random according to a counter.

For another example, when the duty cycle of the discovery burst is smaller than (or no larger than) a first threshold, and/or the transmission duration of the discovery burst is smaller than (or no larger than) a second threshold, the discovery burst can use a first type or a second type of channel access procedure, wherein the channel sensing duration in the first type of channel access procedure is random according to a counter, and the channel sensing duration in the second type of channel access procedure is deterministic (e.g., a fixed value of 25 us).

For one example of the duty cycle, the duty cycle can be defined from a UE perspective, e.g., all components in the discovery burst transmitted by a UE contributes to the duty cycle for the corresponding UE.

For another example of the duty cycle, the duty cycle can be defined from a channel perspective, e.g., all components in the discovery burst transmitted over a channel contributes to the duty cycle for the corresponding channel, which may include the transmission from one or multiple UEs.

For yet another example of the duty cycle, the duty cycle can be defined from a cell perspective, e.g., all components in the discovery burst transmitted in a cell contributes to the duty cycle for the corresponding cell, which may include the transmission from one or multiple UEs and/or one or multiple channels.

For one example of the transmission duration, the transmission duration can be defined from a UE perspective, e.g., all components in the discovery burst transmitted by a UE contributes to the transmission duration for the corresponding UE.

For another example of the transmission duration, the transmission duration can be defined from a channel perspective, e.g., all components in the discovery burst transmitted over a channel contributes to the transmission duration for the corresponding channel, which may include the transmission from one or multiple UEs.

For yet another example of the transmission duration, the transmission duration can be defined from a cell perspective, e.g., all components in the discovery burst transmitted in a cell contributes to the transmission duration for the corresponding cell, which may include the transmission from one or multiple UEs and/or one or multiple channels.

For one example of the first threshold for the duty cycle, the first threshold can be fixed, e.g., 5%.

For another example of the first threshold for the duty cycle, the first threshold can be (pre-)configured. For one example, the (pre-)configured first threshold may not exceed the maximum duty cycle requirement from the regulation, e.g., 5%.

For one example, when S-SS/PSBCH block is included in the S-DB, the duty cycle of the S-SS/PSBCH block can be calculated as defined as D_DB/P_DB, wherein D_DB is the duration of the S-SS/PSBCH block, and P_DB is the periodicity of the S-SS/PSBCH block (e.g., 160 ms).

For one example of the second threshold for the transmission duration, the second threshold can be fixed, e.g., 1 ms.

For another example of the second threshold for the transmission duration, the second threshold can be (pre-)configured. For one example, the (pre-)configured first threshold may not exceed the maximum transmission duration requirement from the regulation, e.g., 1 ms.

In one example, the transmission of a set of S-SS/PBCH blocks can be divided into multiple bursts, and each burst can be potentially multiplexed with other signal/channel to form a discovery burst. The transmission of the discovery burst including a burst of S-SS/PSBCH block can be subject to the channel access procedure described in the disclosure. For one example, the duty cycle and/or transmission duration of the discovery burst can be calculated based on each of the discovery burst including a burst of S-SS/PSBCH block. For another example, the duty cycle and/or transmission duration of the discovery burst can be calculated based on all of the discovery bursts including bursts of S-SS/PSBCH blocks.

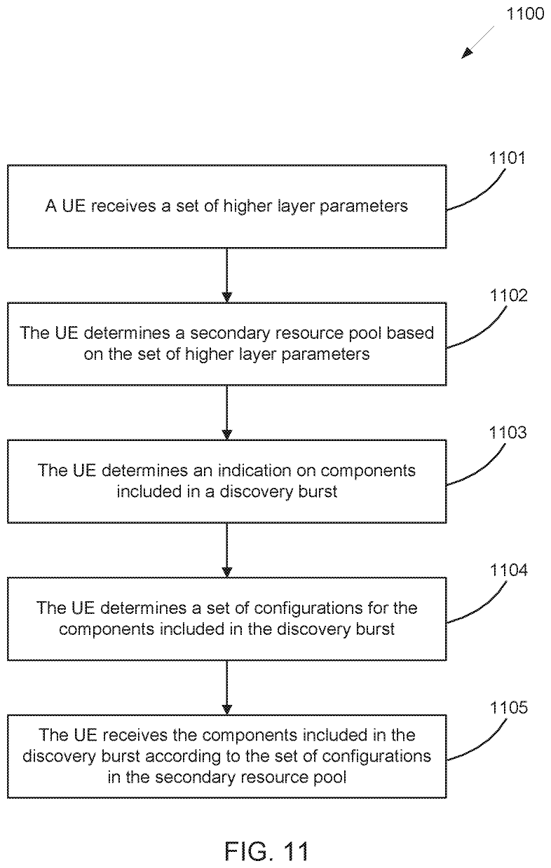

An example UE procedure for receiving discovery burst based on a secondary resource pool is shown in FIG. 11.

FIG. 11 illustrates a flowchart of a UE procedure 1100 for receiving components included in a discovery burst in the secondary resource pool according to embodiments of the present disclosure. For example, the UE procedure 1100 as may be performed by a UE such as 111-116 as illustrated in FIG. 1. An embodiment of the UE procedure 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

A UE first receives a set of higher layer parameters (1101), and determines a secondary resource pool based on the set of higher layer parameters (1102). The UE then determines an indication on components included in a discovery burst (1103), and determines a set of configurations for the components included in the discovery burst (1104). The UE receives the components included in the discovery burst according to the set of configurations in the secondary resource pool (1105).

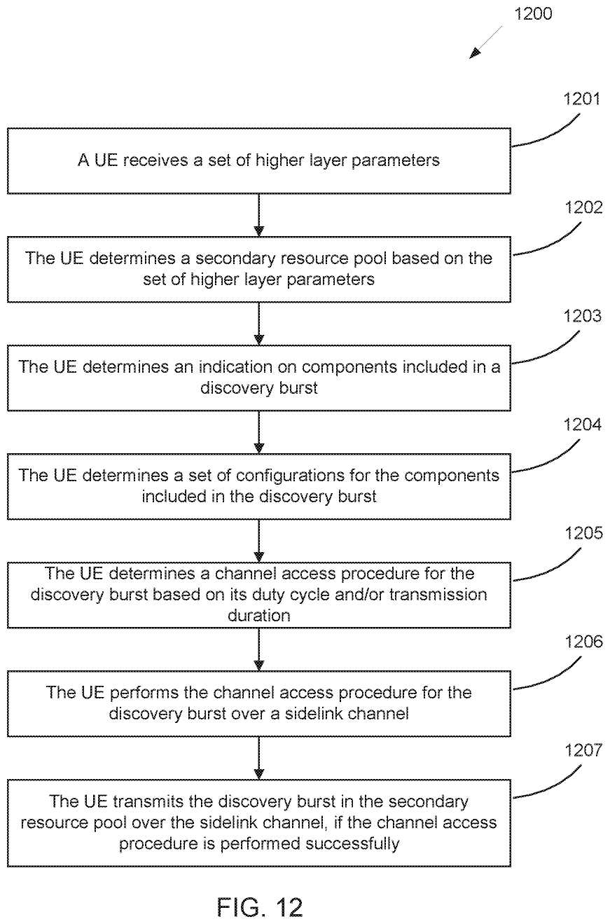

An example UE procedure for receiving discovery burst based on a secondary resource pool is shown in FIG. 12.

FIG. 12 illustrates a flowchart of UE procedure 1200 for transmitting components included in a discovery burst in the secondary resource pool according to embodiments of the present disclosure. For example, the UE procedure 1200 as may be performed by a UE such as 111-116 as illustrated in FIG. 1. An embodiment of the UE procedure 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

A UE first receives a set of higher layer parameters (1201), and determines a secondary resource pool based on the set of higher layer parameters (1202). The UE then determines an indication on components included in a discovery burst (1203), and determines a set of configurations for the components included in the discovery burst (1204). The UE determines a channel access procedure for the discovery burst based on its duty cycle and/or transmission duration (1205), and the UE performs the channel access procedure for the discovery burst over a sidelink channel (1206). The UE transmits the discovery burst in the secondary resource pool over the sidelink channel, if the channel access procedure is performed successfully (1207).

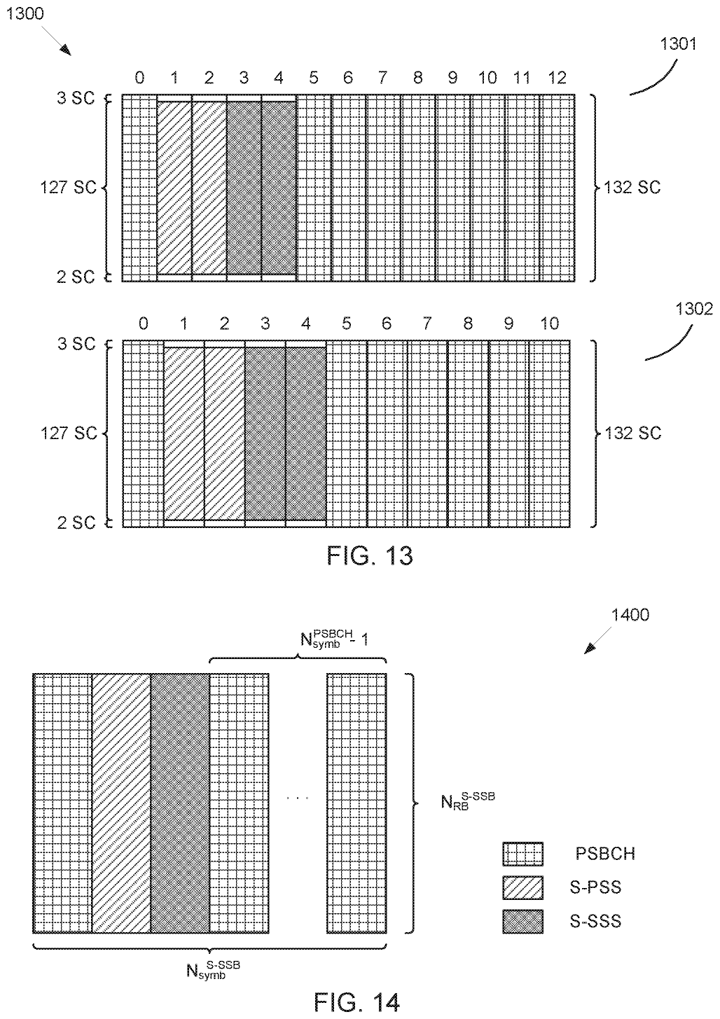

In NR sidelink, sidelink synchronization signals and physical sidelink broadcast channel block (S-SS/PSBCH block or S-SSB) is supported. One S-SS/PSBCH block consists of 132 contiguous subcarriers (SC) in frequency domain and 13 contiguous symbols for normal CP (1301 of FIG. 13) or 11 contiguous symbols for extended CP (1302 of FIG. 13) in time domain. Within a S-SS/PSBCH block, sidelink primary synchronization signal (S-PSS) is mapped to symbol #1 and #2, and sidelink secondary synchronization signal (S-SSS) is mapped to symbol #3 and #4, wherein subcarriers with index 2 to 128 (127 subcarriers in total) are mapped for S-PSS or S-SSS in frequency domain, while subcarriers with indexes 0, 1, 129, 130, and 131 are set as zero. PSBCH is mapped to symbol #0 and #5 to #N_{symb}^{S-SSB}−1, with DM-RS for PSBCH multiplexed in the symbols, wherein N_{symb}^{S-SSB}=13 for normal N_{symb}^{S-SSB}=11 for extended CP. A summary of the mapping in time and frequency domain is shown in TABLE 1.

FIG. 13 illustrates an example of S-SS/PBCH block structure 1300 according to embodiments of the present disclosure. An embodiment of the S-SS/PBCH block structure 1300 shown in FIG. 13 is for illustration only.

For a sidelink operated over an unlicensed spectrum, the transmission of sidelink signals and channels may be subject to the occupied channel bandwidth (OCB) requirement, due to the requirement of regulation for the unlicensed spectrum. For example, for 5 GHz unlicensed spectrum, at least 80% of the nominal channel bandwidth needs to be satisfied when transmitting.

The S-SS/PSBCH block has 11 RBs in the frequency domain, which cannot satisfy the OCB requirement if not multiplexed with other SL signal/channel. Hence, in order to meet the OCB requirement, a new structure of S-SS/PSBCH block could be one method. This disclosure addresses such enhancement for supporting a new S-SS/PSBCH block structure on sidelink, wherein its application could be for unlicensed spectrum, but not limited to unlicensed spectrum.

The present disclosure focuses on supporting at least one novel type of S-SS/PSBCH block structure for at least the unlicensed operation. More precisely, the present disclosure includes the following components: (1) first type of S-SS/PSBCH block structure; (2) second type of S-SS/PSBCH block structure; (3) third type of S-SS/PSBCH block structure; (4) mapping of the new type of S-SS/PSBCH block into time resources; and (5) use of the new type of S-SS/PSBCH block according to the subcarrier spacing.

SS/PSBCH block is mapped for S-PSS, the third symbol in the S-SS/PSBCH block is mapped for S-SSS, and the remaining symbols (e.g., N_{symb}^{PSBCH}−1 number of symbols, wherein N_{symb}^{PSBCH} is the number of symbols for PSBCH in the slot) are mapped for PSBCH. An illustration of the S-SS/PSBCH block is shown in FIG. 14.

FIG. 14 illustrates an example of structure for a S-SS/PSBCH block 1400 according to embodiments of the present disclosure. An embodiment of the structure for a S-SS/PSBCH block 1400 shown in FIG. 14 is for illustration only.

In a first type of S-SS/PSBCH block, the S-SS/PSBCH block has small bandwidth, e.g., N_{RB}^{S-SSB}∈{23, 24}, and a large number of symbols, e.g., N_{symb}^{S-SSB}∈{6, 7}.

In one example for the first type of S-SS/PSBCH block, the PSBCH can be mapped into every RE of all RBs within the S-SS/PSBCH block bandwidth (e.g., N_{symb}^{S-SSB} RBs) and within symbols for PSBCH.

In another example for the first type of S-SS/PSBCH block, the mappings of the sequence for S-PSS and the sequence for S-SSS in the frequency domain are the same.

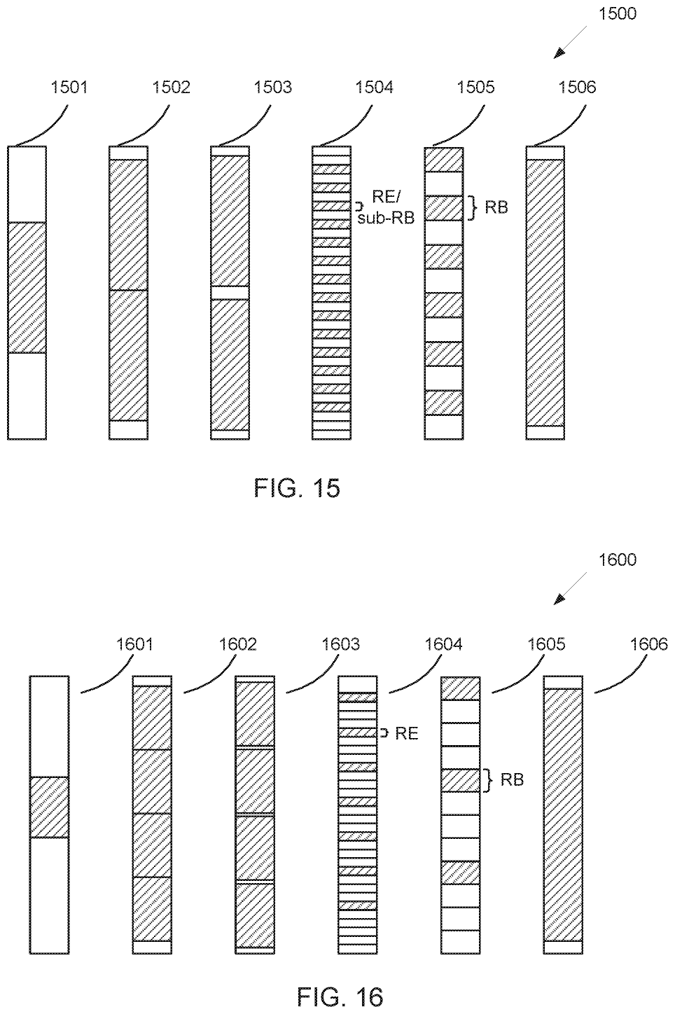

In yet another example for the first type of S-SS/PSBCH block, a length 127 sequence for S-PSS/S-SSS is mapped into the REs in the S-SS/PSBCH block bandwidth and within the symbols for S-PSS/S-SSS, e.g., wherein the center of the length 127 sequence is close to the center of the S-SS/PSBCH block bandwidth (e.g., half subcarrier spacing difference). An illustration of this example is shown in 1501 of FIG. 15.

FIG. 15 illustrates an example of mapping of sequence for S-PSS and/or S-SSS in frequency domain 1500 according to embodiments of the present disclosure. An embodiment of the mapping of sequence for S-PSS and/or S-SSS in frequency domain 1500 shown in FIG. 15 is for illustration only.

In yet another example for the first type of S-SS/PSBCH block, a length 127 sequence for S-PSS/S-SSS is repeated twice, concatenated into a length 254 sequence, and mapped into the REs in the S-SS/PSBCH block bandwidth and within the symbols for S-PSS/S-SSS, e.g., wherein the center of the length 254 sequence is aligned with the center of the S-SS/PSBCH block bandwidth. An illustration of this example is shown in 1502 of FIG. 15.

In yet another example for the first type of S-SS/PSBCH block, a first length 127 sequence for S-PSS/S-SSS is concatenated with a second length 127 sequence for S-PSS/S-SSS into a length 254 sequence, and mapped into the REs in the S-SS/PSBCH block bandwidth and within the symbols for S-PSS/S-SSS, e.g., wherein the first and the second length 127 sequence are mapped in the reversed order, and the center of the length 254 sequence is aligned with the center of the S-SS/PSBCH block bandwidth. An illustration of this example is shown in 1502 of FIG. 15.

In yet another example for the first type of S-SS/PSBCH block, a first length 127 sequence for S-PSS/S-SSS is concatenated with a second length 127 sequence for S-PSS/S-SSS into a length 254 sequence, and mapped into the REs in the S-SS/PSBCH block bandwidth and within the symbols for S-PSS/S-SSS, e.g., wherein the first and the second length 127 sequence are using different cyclic shifts, and the center of the length 254 sequence is aligned with the center of the S-SS/PSBCH block bandwidth. An illustration of this example is shown in 1502 of FIG. 15.

In yet another example for the first type of S-SS/PSBCH block, a length 127 sequence for S-PSS/S-SSS is mapped to 11 RBs (e.g., with 2 lowest REs and 3 highest REs empty in the 11 RBs), and the 11 RBs are repeated twice and each of the repetitions is mapped into the S-SS/PSBCH block bandwidth, wherein the mapping of the two repetitions could be contiguous or non-contiguous. An illustration of this example is shown in 1503 of FIG. 15.

In yet another example for the first type of S-SS/PSBCH block, a first length 127 sequence for S-PSS/S-SSS is mapped to a first block of 11 RBs (e.g., with 2 lowest REs and 3 highest REs empty in the 11 RBs), a second length 127 sequence for S-PSS/S-SSS is mapped to a second block of 11 RBs (e.g., with 2 lowest REs and 3 highest REs empty in the 11 RBs), and the first and second block of 11 RBs are mapped into the S-SS/PSBCH block bandwidth, wherein the mapping of the two blocks of 11 RBs could be contiguous or non-contiguous, and the mapping of the sequences are in reverse order in the first and second blocks. An illustration of this example is shown in 1503 of FIG. 15.

In yet another example for the first type of S-SS/PSBCH block, a first length 127 sequence for S-PSS/S-SSS is mapped to a first block of 11 RBs (e.g., with 2 lowest REs and 3 highest REs empty in the 11 RBs), a second length 127 sequence for S-PSS/S-SSS is mapped to a second block of 11 RBs (e.g., with 2 lowest REs and 3 highest REs empty in the 11 RBs), and the first and second block of 11 RBs are mapped into the S-SS/PSBCH block bandwidth, wherein the mapping of the two blocks of 11 RBs could be contiguous or non-contiguous, and the cyclic shifts for the sequences in the first and second blocks can be different. An illustration of this example is shown in 1503 of FIG. 15.

In yet another example for the first type of S-SS/PSBCH block, a length 127 sequence for S-PSS/S-SSS is concatenated with a number of zero values on each end such that newly constructed sequence is with length 6·N_{RB}^{S-SSB} and the length 127 sequence is located at the center of the newly constructed sequence (e.g., with half subcarrier spacing difference), and the newly constructed sequence is interleaved with an all-zero sequence with length 6·N_{RB}^{S-SSB} and mapped into the REs in the S-SS/PSBCH block bandwidth and within the symbols for S-PSS/S-SSS. For one instance, each RE from the newly constructed sequence can be interleaved with one RE from the all-zero sequence (e.g., RE-level interlace). For another instance, a set of REs from the newly constructed sequence can be interleaved with the same number of REs from the all-zero sequence (e.g., sub-RB-level interlace). An illustration of this example is shown in 1504 of FIG. 15.

In yet another example for the first type of S-SS/PSBCH block, a length 127 sequence is first mapped into N_{RB}^{S-SSB}/2 RBs or (N_{RB}^{S-SSB}+1)/2 RBs (e.g., the sequence located in the center of the RBs), and interleaved with N_{RB}^{S-SSB}/2 RBs or (N_{RB}^{S-SSB}−1)/2 RBs with all zero values, and then mapped into the RBs in the S-SS/PSBCH block bandwidth and within the symbols for S-PSS/S-SSS. An illustration of this example is shown in 1505 of FIG. 15.

In yet another example for the first type of S-SS/PSBCH block, a longer length (e.g., 255) sequence is mapped into the RBs in the S-SS/PSBCH block bandwidth and within the symbols for S-PSS/S-SSS, e.g., such that the sequence is located in the center of the S-SS/PSBCH block bandwidth (with a half subcarrier spacing difference). An illustration of this example is shown in 1506 of FIG. 15.

In yet another example for the first type of S-SS/PSBCH block, the RBs in the S-SS/PSBCH block bandwidth can be divided into two parts (e.g., the upper and lower parts with same size), and each part can follow one example for the first type of S-SS/PSBCH block corresponding to such part of the S-SS/PSBCH block bandwidth.

In yet another example for the first type of S-SS/PSBCH block, the RBs in the S-SS/PSBCH block bandwidth can be divided into two parts (e.g., the upper and lower parts with same size), and one part can follow one example for the first type of S-SS/PSBCH block corresponding to such part of the S-SS/PSBCH block bandwidth, and the other part can be set as zero.

In a second type of S-SS/PSBCH block, the S-SS/PSBCH block has moderate bandwidth, e.g., N_{RB}^{S-SSB}∈{45, . . . , 50}, and moderate number of symbols, e.g., N_{RB}^{S-SSB}∈{4, 5, 6}. {4, 5, 6}.

In one example for the second type of S-SS/PSBCH block, the PSBCH can be mapped into every RE of all RBs within the S-SS/PSBCH block bandwidth (e.g., N_{RB}^{S-SSB} RBs) and within symbols for PSBCH.

In another example for the second type of S-SS/PSBCH block, the mappings of the sequence for S-PSS and the sequence for S-SSS in the frequency domain are the same.

In yet another example for the second type of S-SS/PSBCH block, a length 127 sequence for S-PSS/S-SSS is mapped into the REs in the S-SS/PSBCH block bandwidth and within the symbols for S-PSS/S-SSS, e.g., wherein the center of the length 127 sequence is close to the center of the S-SS/PSBCH block bandwidth (e.g., half subcarrier spacing difference). An illustration of this example is shown in 1601 of FIG. 16.

FIG. 16 illustrates an example of mapping of sequence for S-PSS and/or S-SSS in frequency domain 1600 according to embodiments of the present disclosure. An embodiment of the mapping of sequence for S-PSS and/or S-SSS in frequency domain 1600 shown in FIG. 16 is for illustration only.

In yet another example for the second type of S-SS/PSBCH block, a length 127 sequence for S-PSS/S-SSS is repeated 4 times, concatenated into a length 127·4 sequence, and mapped into the REs in the S-SS/PSBCH block bandwidth and within the symbols for S-PSS/S-SSS, e.g., wherein the center of the length 127·4 sequence is aligned with the center of the S-SS/PSBCH block bandwidth. An illustration of this example is shown in 1602 of FIG. 16.

In yet another example for the second type of S-SS/PSBCH block, four length 127 sequences for S-PSS/S-SSS are concatenated into a length 127·4 sequence, and mapped into the REs in the S-SS/PSBCH block bandwidth and within the symbols for S-PSS/S-SSS, e.g., wherein the second and the forth length 127 sequence are mapped in the reversed order comparing to the first and third length 127 sequence, and the center of the length 127·4 sequence is aligned with the center of the S-SS/PSBCH block bandwidth. An illustration of this example is shown in 1602 of FIG. 16.

In yet another example for the second type of S-SS/PSBCH block, four length 127 sequences for S-PSS/S-SSS are concatenated into a length 127·4 sequence, and mapped into the REs in the S-SS/PSBCH block bandwidth and within the symbols for S-PSS/S-SSS, e.g., wherein four sequences have different cyclic shifts, and the center of the length 127·4 sequence is aligned with the center of the S-SS/PSBCH block bandwidth. An illustration of this example is shown in 1602 of FIG. 16.

In yet another example for the second type of S-SS/PSBCH block, a length 127 sequence for S-PSS/S-SSS is mapped to 11 RBs (e.g., with 2 lowest REs and 3 highest REs empty in the 11 RBs), and the 11 RBs are repeated four times and each of the repetitions is mapped into the S-SS/PSBCH block bandwidth, wherein the mapping of the four repetitions could be contiguous or non-contiguous. An illustration of this example is shown in 1603 of FIG. 16.

In yet another example for the second type of S-SS/PSBCH block, each of four length 127 sequences for S-PSS/S-SSS is mapped to a block of 11 RBs (e.g., with 2 lowest REs and 3 highest REs empty in the 11 RBs), and the four blocks of 11 RBs are mapped into the S-SS/PSBCH block bandwidth, wherein the mapping of the four blocks of 11 RBs could be contiguous or non-contiguous, and the second and the forth length 127 sequence are mapped in the reversed order comparing to the first and third length 127 sequence. An illustration of this example is shown in 1603 of FIG. 16.

In yet another example for the second type of S-SS/PSBCH block, each of four length 127 sequences for S-PSS/S-SSS is mapped to a block of 11 RBs (e.g., with 2 lowest REs and 3 highest REs empty in the 11 RBs), and the four blocks of 11 RBs are mapped into the S-SS/PSBCH block bandwidth, wherein the mapping of the four blocks of 11 RBs could be contiguous or non-contiguous, and the cyclic shifts for the sequences in the four blocks can be different. An illustration of this example is shown in 1603 of FIG. 16.

In yet another example for the second type of S-SS/PSBCH block, a length 127 sequence for S-PSS/S-SSS is concatenated with a number of zero values on each end such that newly constructed sequence is with length 3·N_{RB}^{S-SSB} and the length 127 sequence is located at the center of the newly constructed sequence (e.g., with half subcarrier spacing difference), and the newly constructed sequence is interleaved with an all-zero sequence with length 9·N_{RB}^{S-SSB} and mapped into the REs in the S-SS/PSBCH block bandwidth and within the symbols for S-PSS/S-SSS. For one instance, each RE from the newly constructed sequence can be interleaved with three consecutive REs from the all-zero sequence (e.g., RE-level interlace). For another instance, a set of REs from the newly constructed sequence can be interleaved with three times the number of REs from the all-zero sequence (e.g., sub-RB-level interlace). An illustration of this example is shown in 1604 of FIG. 16.

In yet another example for the second type of S-SS/PSBCH block, a length 127 sequence is second mapped into N_{RB}^{S-SSB}/4 RBs or (N_{RB}^{S-SSB}+3)/4 RBs (e.g., the sequence located in the center of the RBs), and interleaved with 3·N_{RB}^{S-SSB}/4 RBs or (3·N_{RB}^{S-SSB}−3)/4 RBs with all zero values (in a way of one RB from the RBs including sequence interleaved with three RBs from the zero values), and then mapped into the RBs in the S-SS/PSBCH block bandwidth and within the symbols for S-PSS/S-SSS. An illustration of this example is shown in 1605 of FIG. 16.

In yet another example for the second type of S-SS/PSBCH block, a longer length (e.g., 511) sequence is mapped into the RBs in the S-SS/PSBCH block bandwidth and within the symbols for S-PSS/S-SSS, e.g., such that the sequence is located in the center of the S-SS/PSBCH block bandwidth (with a half subcarrier spacing difference). An illustration of this example is shown in 1606 of FIG. 16.

In yet another example for the second type of S-SS/PSBCH block, the RBs in the S-SS/PSBCH block bandwidth can be divided into two parts (e.g., the upper and lower parts with same size), and each part can follow one example for the second type of S-SS/PSBCH block corresponding to such part of the S-SS/PSBCH block bandwidth.

In yet another example for the second type of S-SS/PSBCH block, the RBs in the S-SS/PSBCH block bandwidth can be divided into four parts (e.g., each part with same size), and each part can follow one example for the second type of S-SS/PSBCH block corresponding to such part of the S-SS/PSBCH block bandwidth.

In a third type of S-SS/PSBCH block, the S-SS/PSBCH block has large bandwidth, e.g., N_{RB}^{S-SSB}∈{89, ..., 105}, and small number of symbols, e.g., N_{RB}^{S-SSB}∈{4, 5, 6}.

In one example for the third type of S-SS/PSBCH block, the PSBCH can be mapped into every RE of all RBs within the S-SS/PSBCH block bandwidth (e.g., N_{RB}^{S-SSB} RBs) and within symbols for PSBCH.

In another example for the third type of S-SS/PSBCH block, the mappings of the sequence for S-PSS and the sequence for S-SSS in the frequency domain are the same.

In yet another example for the third type of S-SS/PSBCH block, a length 127 sequence for S-PSS/S-SSS is mapped into the REs in the S-SS/PSBCH block bandwidth and within the symbols for S-PSS/S-SSS, e.g., wherein the center of the length 127 sequence is close to the center of the S-SS/PSBCH block bandwidth (e.g., half subcarrier spacing difference).

In yet another example for the third type of S-SS/PSBCH block, a length 127 sequence for S-PSS/S-SSS is repeated 8 times, concatenated into a length 127·8 sequence, and mapped into the REs in the S-SS/PSBCH block bandwidth and within the symbols for S-PSS/S-SSS, e.g., wherein the center of the length 127·8 sequence is aligned with the center of the S-SS/PSBCH block bandwidth.

In yet another example for the third type of S-SS/PSBCH block, eight length 127 sequences for S-PSS/S-SSS are concatenated into a length 127·8 sequence, and mapped into the REs in the S-SS/PSBCH block bandwidth and within the symbols for S-PSS/S-SSS, e.g., wherein the second, forth, sixth, and the eighth length 127 sequence are mapped in the reversed order comparing to the first, third, fifth, and seventh length 127 sequence, and the center of the length 127·8 sequence is aligned with the center of the S-SS/PSBCH block bandwidth.

In yet another example for the third type of S-SS/PSBCH block, eight length 127 sequences for S-PSS/S-SSS are concatenated into a length 127·8 sequence, and mapped into the REs in the S-SS/PSBCH block bandwidth and within the symbols for S-PSS/S-SSS, e.g., wherein eight sequences have different cyclic shifts, and the center of the length 127·8 sequence is aligned with the center of the S-SS/PSBCH block bandwidth.

In yet another example for the third type of S-SS/PSBCH block, a length 127 sequence for S-PSS/S-SSS is mapped to 11 RBs (e.g., with 2 lowest REs and 3 highest REs empty in the 11 RBs), and the 11 RBs are repeated eight times and each of the repetitions is mapped into the S-SS/PSBCH block bandwidth, wherein the mapping of the eight repetitions could be contiguous or non-contiguous.

In yet another example for the third type of S-SS/PSBCH block, each of eight length 127 sequences for S-PSS/S-SSS is mapped to a block of 11 RBs (e.g., with 2 lowest REs and 3 highest REs empty in the 11 RBs), and the eight blocks of 11 RBs are mapped into the S-SS/PSBCH block bandwidth, wherein the mapping of the eight blocks of 11 RBs could be contiguous or non-contiguous, and the second, forth, sixth, and the eighth length 127 sequence are mapped in the reversed order comparing to the first, third, fifth, and seventh length 127 sequence.

In yet another example for the third type of S-SS/PSBCH block, each of eight length 127 sequences for S-PSS/S-SSS is mapped to a block of 11 RBs (e.g., with 2 lowest REs and 3 highest REs empty in the 11 RBs), and the eight blocks of 11 RBs are mapped into the S-SS/PSBCH block bandwidth, wherein the mapping of the eight blocks of 11 RBs could be contiguous or non-contiguous, and the cyclic shifts for the sequences in the eight blocks can be different.

In yet another example for the third type of S-SS/PSBCH block, a length 127 sequence for S-PSS/S-SSS is concatenated with a number of zero values on each end such that newly constructed sequence is with length 12·N_{RB}^{S-SSB}/8 and the length 127 sequence is located at the center of the newly constructed sequence (e.g., with half subcarrier spacing difference), and the newly constructed sequence is interleaved with an all-zero sequence with length 12·N_{RB}^{S-SSB}·7/8 and mapped into the REs in the S-SS/PSBCH block bandwidth and within the symbols for S-PSS/S-SSS. For one instance, each RE from the newly constructed sequence can be interleaved with seven consecutive REs from the all-zero sequence (e.g., RE-level interlace). For another instance, a set of REs from the newly constructed sequence can be interleaved with seven times the number of REs from the all-zero sequence (e.g., sub-RB-level interlace).

In yet another example for the third type of S-SS/PSBCH block, a length 127 sequence is third mapped into N_{RB}^{S-SSB}/8 RBs or (N_{RB}^{S-SSB}+7)/8 RBs (e.g., the sequence located in the center of the RBs), and interleaved with 7·N_{RB}^{S-SSB}/8 RBs or (7·N_{RB}^{S-SSB}−7)/8 RBs with all zero values (in a way of one RB from the RBs including sequence interleaved with seven RBs from the zero values), and then mapped into the RBs in the S-SS/PSBCH block bandwidth and within the symbols for S-PSS/S-SSS.

In yet another example for the third type of S-SS/PSBCH block, a longer length (e.g., 1023) sequence is mapped into the RBs in the S-SS/PSBCH block bandwidth and within the symbols for S-PSS/S-SSS, e.g., such that the sequence is located in the center of the S-SS/PSBCH block bandwidth (with a half subcarrier spacing difference).

In yet another example for the third type of S-SS/PSBCH block, the RBs in the S-SS/PSBCH block bandwidth can be divided into two parts (e.g., the upper and lower parts with same size), and each part can follow one example for the second type of S-SS/PSBCH block corresponding to such part of the S-SS/PSBCH block bandwidth.

In yet another example for the third type of S-SS/PSBCH block, the RBs in the S-SS/PSBCH block bandwidth can be divided into eight parts (e.g., each part with same size), and each part can follow one example for the second type of S-SS/PSBCH block corresponding to such part of the S-SS/PSBCH block bandwidth.

In one embodiment, the S-SS/PSBCH block, as described in the examples of the present disclosure, can be mapped into a time unit, and the time unit can periodically show up in time domain to form a transmission pattern for the S-SS/PSBCH block. For instance, the transmission pattern can be determined based on at least one of a size of the time unit (e.g., Nᵤₙᵢₜ^{slot}), an interval between the neighboring time duration (e.g., Nᵢₙₜₑᵣᵥₐₗ^{slot} ), an offset of the first time unit in the period (e.g., N_{offset}^{slot}), a number of S-SS/PSBCH block within the time unit (e.g., Nᵤₙᵢₜ^{S-SSB}), and a number of S-SS/PSBCH block to be transmitted in a period (e.g., N_{period}^{S-SSB}).

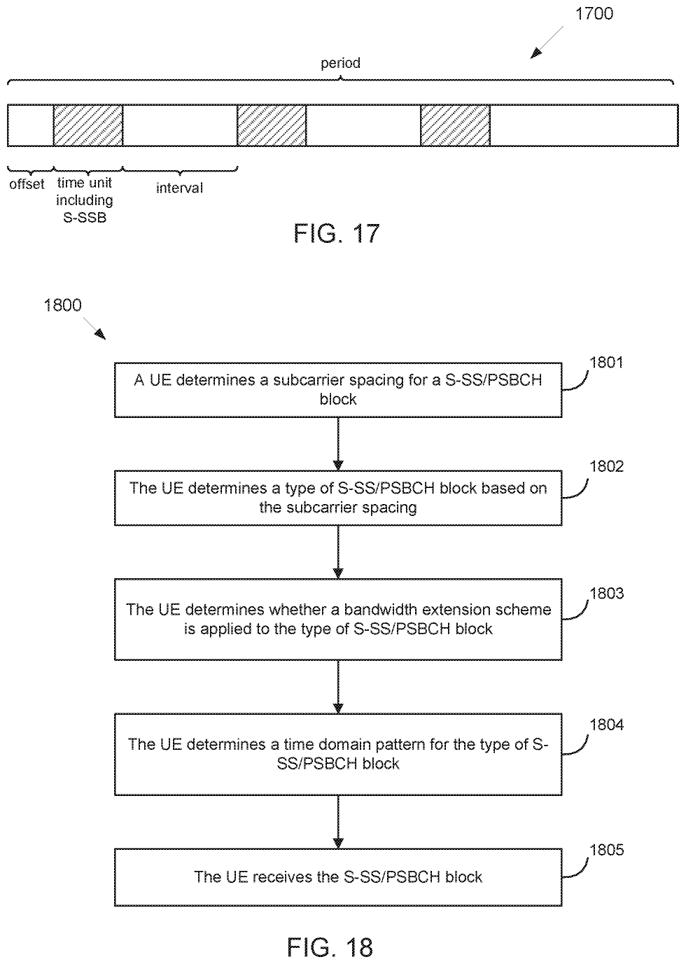

For one example, the transmission pattern of the S-SS/PSBCH block is confined within a period (e.g., fixed as 16 frames), and the transmission of S-SS/PSBCH block in the period is with a periodicity same as the duration of the period (e.g., 16 frames). The indexes of slots including the S-SS/PSBCH block can be determined as N_{offset}^{slot}+(Nᵢₙₜₑᵣᵥₐₗ^{slot}+Nᵤₙᵢₜ^{slot})·[i_{S-SSB}/Nᵤₙᵢₜ^{S-SSB}], where i_{S-SSB} is the S-SS/PSBCH block index within the period, with 0≤i_{S-SSB}≤N_{period}^{S-SSB}−1. An illustration of this example is shown in FIG. 17.

FIG. 17 illustrates an example of S-SS/PSBCH block transmission pattern 1700 according to embodiments of the present disclosure. An embodiment of the S-SS/PSBCH block transmission pattern 1700 shown in FIG. 17 is for illustration only.

In one example of the example, the starting symbol of S-SS/PSBCH block (e.g., S_{symb}) within the time unit (e.g., 14·Nᵤₙᵢₜ^{slot} for normal CP and 12·Nᵤₙᵢₜ^{slot} for extended CP, and starting with symbol #0) can be determined according to one of the following sub-example in TABLE 2 for normal CP or TABLE 3 for extended CP, wherein the determination can be based on at least one of the number of slots for the time unit, the number of symbols for a S-SS/PSBCH block according to the example of this disclosure, and the number of S-SS/PSBCH blocks within the time unit. For instance, the starting symbol of the S-SS/PSBCH block in the period is given by S_{symb}+N_{symb}^{slot}·n, wherein n is given by N_{offset}^{slot}+(Nᵢₙₜₑᵣᵥₐₗ^{slot}·Nᵤₙᵢₜ^{slot})·[i_{S-SSB}/Nᵤₙᵢₜ^{S-SSB}], and the index with 0 corresponds to the first symbol in the first slot of this period.

TABLE 2
Example starting symbol of S-SS/PSBCH block within the
time unit for normal CP.

| sub- | | | | |
|---|---|---|---|---|
| example # | Nᵤₙᵢₜ^{slot} | N_{symb}^{S-SSB} | Nᵤₙᵢₜ^{S-SSB} | S_{symb} |
| 1 | 1 | 4 | 1 | {0} |
| 2 | 1 | 5 | 1 | {0} |
| 3 | 1 | 6 | 1 | {0} |
| 4 | 1 | 7 | 1 | {0} |
| 5 | 1 | 4 | 2 | {0, 5} |
| 6 | 1 | 4 | 2 | {0, 7} |
| 7 | 1 | 5 | 2 | {0, 6} |
| 8 | 1 | 5 | 2 | {0, 7} |
| 9 | 1 | 6 | 2 | {0, 7} |
| 10 | 1 | 7 | 2 | {0, 7} |
| 11 | 1 | 4 | 3 | {0, 4, 8} |
| 12 | 1 | 4 | 3 | {0, 5, 10} |
| 13 | 2 | 4 | 5 | {0, 5, 10, 15, 20} |
| 14 | 2 | 7 | 3 | {0, 8, 16} |
| 15 | 2 | 7 | 3 | {0, 9, 18} |

TABLE 3
Example starting symbol of S-SS/PSBCH block within the time unit
for extended CP.

| sub- | | | | |
|---|---|---|---|---|
| example # | Nᵤₙᵢₜ^{slot} | N_{symb}^{S-SSB} | Nᵤₙᵢₜ^{S-SSB} | S_{symb} |
| 1 | 1 | 4 | 1 | {0} |
| 2 | 1 | 5 | 1 | {0} |
| 3 | 1 | 6 | 1 | {0} |
| 4 | 1 | 7 | 1 | {0} |
| 5 | 1 | 4 | 2 | {0, 5} |
| 6 | 1 | 4 | 2 | {0, 6} |
| 7 | 1 | 5 | 2 | {0, 6} |
| 8 | 1 | 6 | 2 | {0, 6} |
| 9 | 1 | 4 | 3 | {0, 4, 8} |
| 10 | 2 | 6 | 3 | {0, 7, 14} |
| 11 | 2 | 6 | 3 | {0, 8, 16} |
| 12 | 2 | 7 | 3 | {0, 8, 16} |

In one embodiment, a UE can determine a type of S-SS/PSBCH block based on the SCS of the S-SS/PSBCH block.

For one example, if the SCS of the S-SS/PSBCH block is 15 kHz, the UE assumes the third type of S-SS/PSBCH block is used.

For another example, if the SCS of the S-SS/PSBCH block is 30 kHz, the UE assumes the second type of S-SS/PSBCH block is used.

For yet another example, if the SCS of the S-SS/PSBCH block is 60 kHz, the UE assumes the first type of S-SS/PSBCH block is used.

For yet another example, if the SCS of the S-SS/PSBCH block is 15 kHz, the UE assumes the second type of S-SS/PSBCH block combined with one of the example bandwidth extension schemes as described in this disclosure is used, wherein the extension factor is 2.

For yet another example, if the SCS of the S-SS/PSBCH block is 30 kHz, the UE assumes the first type of S-SS/PSBCH block combined with one of the example bandwidth extension schemes as described in this disclosure is used, wherein the extension factor is 2.

For yet another example, if the SCS of the S-SS/PSBCH block is 15 kHz, the UE assumes the first type of S-SS/PSBCH block combined with one of the example bandwidth extension schemes as described in this disclosure is used, wherein the extension factor is 4.

In a first example for bandwidth extension scheme, a S-SS/PSBCH block with bandwidth N_{RB}^{S-SSB} RBs can be repeated Nₑₓₜ times in the frequency domain, wherein Nₑₓₜ is the extension factor, and empty RBs could be potentially added between neighboring repeated S-SS/PSBCH blocks such that the bandwidth after extension is no smaller than Nₑₓₜ·N_{RB}^{S-SSB}.

In a second example for bandwidth extension scheme, a S-SS/PSBCH block with bandwidth N_{RB}^{S-SSB} RBs can be interleaved with RBs with all zero values, wherein each RB in the S-SS/PSBCH block can be interleaved with Nₑₓₜ−1 RBs with all zero values in the frequency domain, and Nₑₓₜ is the extension factor, such that the bandwidth after extension is Nₑₓₜ·N_{RB}^{S-SSB}.

In a third example for bandwidth extension scheme, a S-SS/PSBCH block with bandwidth N_{RB}^{S-SSB} RBs can be interleaved with REs with all zero values, wherein each RE in the S-SS/PSBCH block can be interleaved with Nₑₓₜ−1 REs with all zero values in the frequency domain, and Nₑₓₜ is the extension factor, such that the bandwidth after extension is Nₑₓₜ·N_{RB}^{S-SSB}.

FIG. 18 illustrates a flowchart of a UE procedure 1800 on receiving S-SS/PSBCH block based on the type of S-SS/PSBCH block according to embodiments of the present disclosure. For example, the UE procedure 1800 as may be performed by a UE such as 111-116 as illustrated in FIG. 1. An embodiment of the UE procedure 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

The procedure 1800 begins with the UE determining a subcarrier spacing for a S-SS/PSBCH block (1801). The UE then determines a type of S-SS/PSBCH block based on the subcarrier spacing (1802). The UE determines whether a bandwidth extension scheme is applied to the type of S-SS/PSBCH block (1803). The UE determines a time domain pattern for the type of S-SS/PSBCH block (1804). The UE then receives the S-SS/PSBCH block (1805), with the method terminating thereafter.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
identify a set of sidelink (SL) synchronization signals and physical SL broadcast channel (S-SS/PSBCH) blocks for a SL discovery burst;
determine a transmission duration of the SL discovery burst;
determine a duty cycle of the SL discovery burst;
determine, based on the transmission duration and the duty cycle, a type of SL channel access procedure; and
perform, based on the type of SL channel access procedure, a SL channel access procedure; and
a transceiver operably coupled to the processor, the transceiver configured to transmit the SL discovery burst after successfully performing the SL channel access procedure.

2. The UE of claim 1, wherein the SL channel access procedure is determined as a first type of SL channel access procedure, when the transmission duration is no larger than a first threshold and the duty cycle is no larger than a second threshold.

3. The UE of claim 2, wherein the first type of SL channel access procedure includes a time duration spanned by sensing slots that are sensed to be idle before a SL transmission is deterministic as 25 microseconds.

4. The UE of claim 2, wherein the first threshold for the transmission duration is 1 millisecond.

5. The UE of claim 2, wherein the second threshold for the duty cycle is 5 percent.

6. The UE of claim 1, wherein the processor is further configured to determine the type of SL channel access procedure as a second type of SL channel access procedure.

7. The UE of claim 6, wherein the second type of SL channel access procedure includes a time duration spanned by sensing slots that are sensed to be idle before a SL transmission is random and based on a counter.

8. The UE of claim 1, wherein the SL discovery burst includes a set of physical SL feedback channels (PSFCHs).

9. The UE of claim 1, wherein:
the processor is further configured to identify a resource pool,
the resource pool includes resource blocks (RBs) in a set of slots, and
each slot in the set of slots includes an S-SS/PSBCH block in the set of S-SS/PSBCH blocks and the RBs do not overlap with the S-SS/PSBCH block.

10. The UE of claim 9, wherein the transceiver is further configured to transmit a SL positioning reference signal (SL-PRS) based on the resource pool.

11. A method of a user equipment (UE) in a wireless communication system, the method comprising:
identifying a set of sidelink (SL) synchronization signals and physical SL broadcast channel (S-SS/PSBCH) blocks for a SL discovery burst;
determining a transmission duration of the SL discovery burst;
determining a duty cycle of the SL discovery burst;
determining, based on the transmission duration and the duty cycle, a type of SL channel access procedure;
performing, based on the type of SL channel access procedure, a SL channel access procedure; and
transmitting the SL discovery burst after successfully performing the SL channel access procedure.

12. The method of claim 11, wherein the SL channel access procedure is determined as a first type of SL channel access procedure, when the transmission duration is no larger than a first threshold and the duty cycle is no larger than a second threshold.

13. The method of claim 12, wherein the first type of SL channel access procedure includes a time duration spanned by sensing slots that are sensed to be idle before a SL transmission is deterministic as 25 microseconds.

14. The method of claim 12, wherein the first threshold for the transmission duration is 1 millisecond.

15. The method of claim 12, wherein the second threshold for the duty cycle is 5 percent.

16. The method of claim 11, wherein determining the type of SL channel access procedure further comprises determining the type of SL channel access procedure as a second type of SL channel access procedure.

17. The method of claim 16, wherein the second type of SL channel access procedure includes a time duration spanned by sensing slots that are sensed to be idle before a SL transmission is random and based on a counter.

18. The method of claim 11, wherein the SL discovery burst includes a set of physical SL feedback channels (PSFCHs).

19. The method of claim 11 further comprising:
identifying a resource pool, wherein:
the resource pool includes resource blocks (RBs) in a set of slots, and
each slot in the set of slots includes an S-SS/PSBCH block in the set of S-SS/PSBCH blocks and the RBs do not overlap with the S-SS/PSBCH block.

20. The method of claim 19 further comprising transmitting a SL positioning reference signal (SL-PRS) based on the resource pool.
